(19) United States
(12) Patent Application Publication
(10) Pub. No.: US 2014/0115825 A1
(43) Pub. Date: May 1, 2014

(54) A HINGE FOR FOR FIREPROOF DOOR

(71) Applicant: Gap Hwan Park, Gimhae-si (KR)

(72) Inventor: Gap Hwan Park, Gimhae-si (KR)

(21) Appl. No.: 14/116,407

(22) PCT Filed: May 10, 2012
(86) PCT No.: PCT/KR2012/003652

§ 371 Date: Jan. 15, 2014

(30) Foreign Application Priority Data
May 11, 2011 (KR) 10-02011-0043910

(51) Int. Cl. E05D 11/00

(52) U.S. Cl. CPC E05D 11/00
USPC 16/223

(57) ABSTRACT

Disclosed are a hinge for a fire door in which a water supply path is formed for supplying water from a fire-door frame to the interior of the fire door upon the outbreak of a fire. A water supply path is formed from a doorframe to a door so as to supply water contained in the interior of the doorframe to the interior of the door, making it possible to supply water from the doorframe to the door. Thus, water can be continuously supplied to the interior of the door as well as to the doorframe, thereby not only blocking flames and heat, but also extinguishing the flames.

### TECHNICAL FIELD

This invention is about the hinge for fireproof door. To be more specific, it is about the hinge of a fireproof door that has the water supply route with the purpose of supplying the water to the inner part of the fireproof door from the fireproof doorframe in case of fire.

### BACKGROUND ART

Patent Number 10-0995224 is about the fireproof door that blocks the heat by letting the water flow to the inner parts and prevents toxic gas from seeping in to the interior by sealing the crack between the door and the doorframe in case of fire. Furthermore, Patent Application number 10-2009-0124808 is about the hinge of the fireproof door that release water in case of fire to block the heat and prevents toxic gas from seeping in to the interior by sealing the crack between the door and the doorframe. In order for fireproof door and fireproof hinge to work normally, water should be constantly supplied towards the inner parts of the fireproof door and the fireproof hinge in case of fire.

In case of hinged door, the door is connected to a hinge. The doorframe is always in its place and it is relatively easy to supply water into it. But the door moves with the doorframe and does not stay fixed in one place. Therefore, it will not be efficient to install the equipment that provides water to inside of the door in case when fire had already started.

### DISCLOSURE

### Technical Problem

This invention aims to resolve the problem as stated above and to provide fireproof hinge that may serve as the water supply route from fireproof doorframe to the fireproof door.

### Technical Solution

Fireproof door's hinge in accordance to this invention forms water supply route from the doorframe to the door so that the water that is within the doorframe may be admitted into the doorframe.

Moreover, in case of fireproof door's hinge as mentioned above, it is recommended that hinge be composed of hinge, part that connects to the door and doorframe connecting part.

The hinge part has water containment area on the inside and one side can rotate the other side.

Part that connects to the door as mentioned above is connected to the door as mentioned above in one part and the other side is connected to the part of the hinge's side. The door frame connector's side is connected to the door frame as mentioned above, thus forming the second water route from the doorframe to the water containment area as mentioned above.

Moreover, in case of fireproof door's hinge, it is recommended that the hinge part be composed of upper cylinder and the lower cylinder. The lower cylinder as mentioned above will be connected to connecting part of the door frame as mentioned above. On the inside, upper part had been opened so that it will form the lower part of the water containment area which will be connected to the second water supply route as it had been mentioned above and the pivot point is protruding on the outer surface. The upper cylinder as mentioned above will be joined to the part that connects to the door as mentioned above. On the inside, lower part had been opened so that it will form the upper part of the water containment area which will be connected to the first water supply route as it had been mentioned above and furrow should be formed so that pivot point can be inserted on the lower side. And the upper cylinder can rotate with the lower cylinder.

### Advantageous Effects

According to this invention, water can be supplied from the doorframe to the door by providing the hinge that forms the water supply route from door frame to the door that allows the water contained in the door frame to be supplied to the inner part of the door.

In this case, water can be continuously provided to the inside of the door and not just the door frame which in turn put the fire out as well as blocking the fire and the heat in case of fire.

### DESCRIPTION OF DRAWINGS

FIG. 1 depicts the slanted diagram of the fireproof door's hinge according to this invention as an example.

FIG. 2 depicts another slanted diagram according to FIG. 1 from another view point as an example.

FIG. 3 is the flat assembly diagram regarding FIG. 1.

FIG. 4 is the cross sectional diagram of the example give in FIG. 1 from the view point of A-A

FIG. 5 is the installation diagram depicted in FIG. 1.

### EXPLANATION REGARDING THE SIGNS

1: doorframe 5: door

10: hinge 11: hinge part

13: water containment area 15: lower cylinder

16: pivot point 17: interior

19: upper cylinder 20: furrow

21: interior 25: part that connects to the door

27: first water supply route 28: screw hole

30: part that connects to the door frame 31: second water supply route

32: screw hole 25: water supply route

### BEST MODE

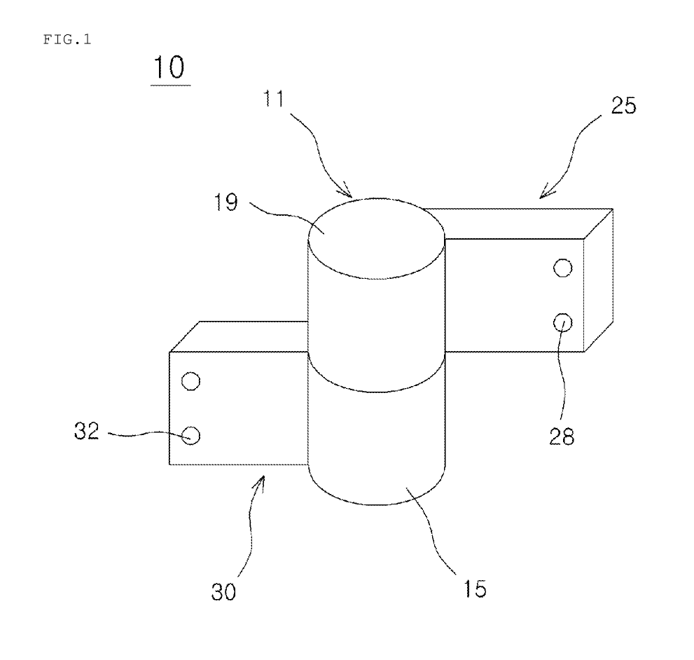

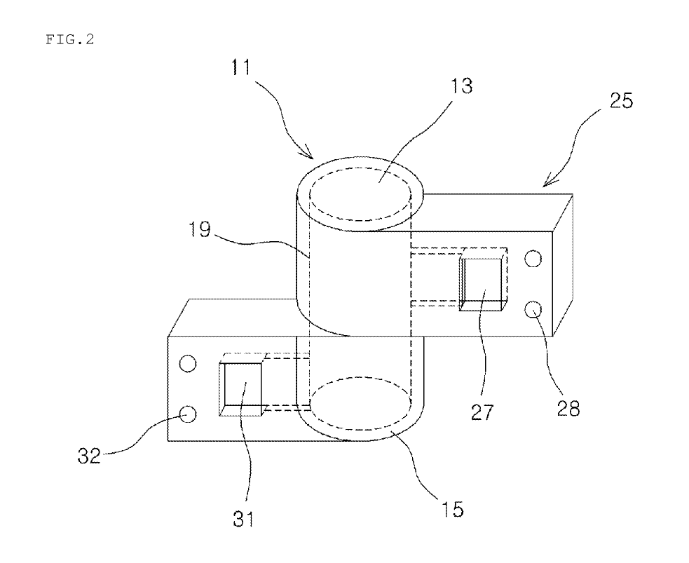

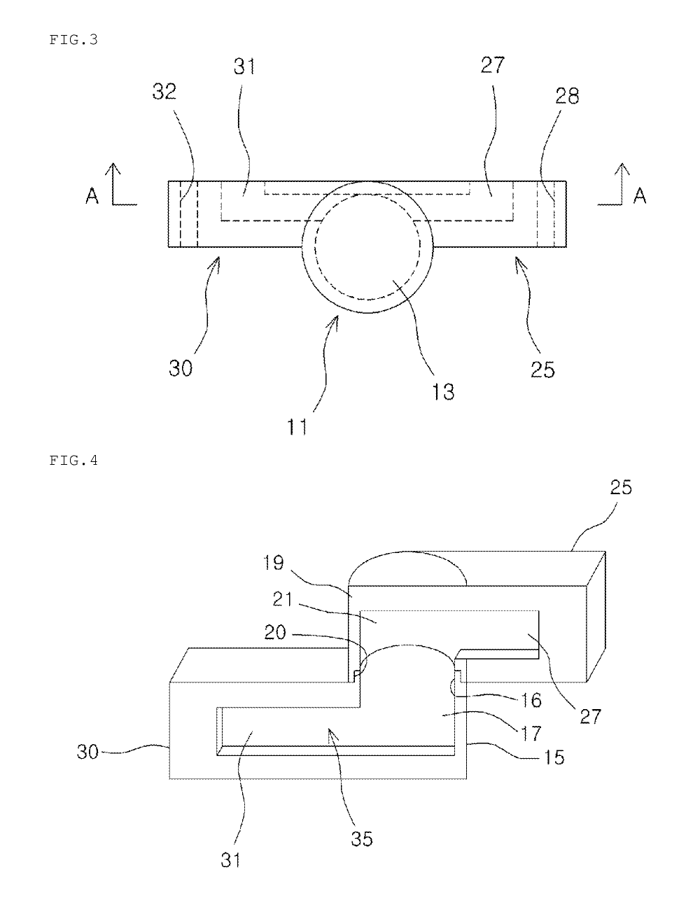

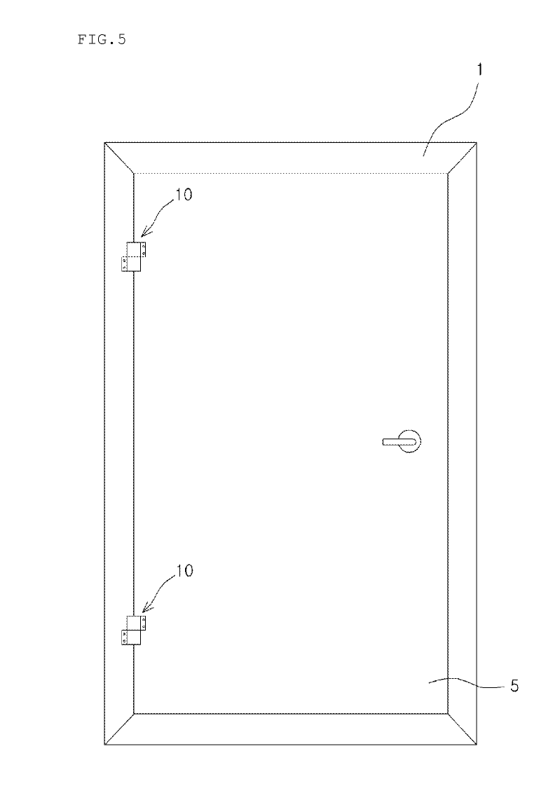

Example of fireproof door's hinge regarding this invention will be explained through FIGS. 1 to 5.

According to this invention, fireproof door's hinge (10) forms the water supply route (35) that extends from doorframe (1) to the door (5) so that the water contained inside the doorframe (1) can be supplied into the door (5).

For this purpose, hinge is equipped with the hinge part (11), part that connects to the door (25) and connecting part to the door frame (30).

The hinge (11) has is equipped with water containment area (13) that forms the water supply route (35) on the inside. And one side of the hinge (11) can rotate the other side. For this purpose, the hinge (11) is equipped with lower cylinder (15) and the upper cylinder (19).

Lower cylinder (15) is in a cylindrical shape where the upper part is opened so that the interior (17) can form the lower part of the water containment area (13). The pivot point is protruding on the outer surface along the outer circumference. And connecting part to the door frame is also connected to the lower cylinder (15).

The upper cylinder (19) is in a cylindrical shape where lower part had been opened so that the interior (21) will form the upper part of the water containment area (13). And part that connects to the door (25) is attached to the upper cylinder (19). When the pivot point (16) of the lower cylinder (15) is inserted to the furrow (20) of the upper cylinder (19) and when the lower and upper cylinder is merged, water containment area (13) is formed on the inside. And the upper cylinder can rotate with the lower cylinder.

Part that connects to the door (25) will be joined to the door (5) and the other side will be connected to the upper cylinder (19). Part that connects to the door (25) can be connected to the door (5) through the screw hole (28). And within the part that connects to the door (25), there is the first water supply route (27) that has been formed from the door (5) to the upper cylinder (19) towards the inside (21). The first water supply route (27) is the water supply route (35) from the door (5) to the water containment area (35).

One side of the water containment area (31) is joined to the door frame (1) and the other side is connected to the lower cylinder (15). Part that connects to the doorframe (30) can be joined in the door frame (1) through the screw hole (32). And in the part that connects to the doorframe (30) is the second water supply route (31) which is connected from the doorframe (1) to the inner part (17) of the lower cylinder (17). The second water supply (31) composes the water supply route (35) from water containment area (13) to the doorframe (1).

Actual example regarding the movements is provided as per description below.

As the actual example, doorframe (1) and the door (5) have the space inside that can contain water. The part that connects to the doorframe (30) is connected to the doorframe (1) and the part that connects to the door (25) is connected to the door (5). Then, a hole is formed where the space within the doorframe's (1) space and the second water supply (31) can be connected.

Then on the door (5), hole is also formed where first water supply route (27) so that the part that connects the door (25) and space in the door (5) can be connected.

And the door (5) is joined to the doorframe (1) so that the pivot point (16) of the lower cylinder (15) can be inserted to the furrow (20) of the upper cylinder (19). As the pivot point (16) can be inserted or separated from the furrow (20), the door (5) can be joined or separated from the doorframe (1). In other words, upper cylinder (19) and lower cylinder (15) of the hinge (11) can be separated or joined together.

When upper cylinder (19) and the lower cylinder (15) come together, first water supply route (27) water containment area (13) and second water supply route (15) complete the water supply route (35). Moreover, upper cylinder (19) can rotate the lower cylinder (15) thus able to carry out the task of the hinge as well.

In case of fire, water will be supplied to the doorframe (1). The water that has been supplied to the doorframe (1) can be supplied to the inner parts of the door (5) through the water supply route (35). In other words, the water can be continuously supplied from the doorframe (1) to the hinge (10) through the water supply route (35) to the inner parts of the door (5).

Now the door (5) can block the fire and smoke through the water supplied by the door (5).

Thus, in accordance with the given example, it is easy to provide water from doorframe (1) to the door (5) in case of fire.

1. Fireproof door hinge that has the water supply route from the doorframe to the door which allows the water within the doorframe to be supplied to the inner part of the door.

2. As per claim 1, fireproof door's hinge has the following characteristics such as hinge that has water containment area on the inside, hinge where one part can move the other where one part is joined to the door as mentioned above and other side is connected to the above mentioned hinge part, part that connects to the door where the first water supply route is formed that connects from the door and the water connecting part, one side is connected to the doorframe, and the other side is connected to the other hinge part as mentioned above, and doorframe connecting part where second water supply route is formed in which it is connected from the doorframe and water containment part.

3. As per claim 2, fireproof door's hinge has the following characteristics such as the above mentioned hinge connecting to the doorframe connecting part, lower cylinder where the upper part had been opened so that the inner part can form the lower part of the water containment part as mentioned above where it is connected to the second water route and pivot point is protruding in the outer surface and where lower part was opened so that the inner part can form the upper part of the water containment area as mentioned above, where upper cylinder with the furrow on the lower part is formed so that the above mentioned pivot point can be inserted and where upper cylinder can rotate the lower cylinder.
